(19) United States
(12) Patent Application Publication
(10) Pub. No.: US 2011/0067407 A1
(43) Pub. Date: Mar. 24, 2011

(54) FLAME-HOLDER DEVICE COMPRISING AN ARM SUPPORT AND A HEAT-PROTECTION SCREEN THAT ARE IN ONE PIECE

(75) Inventors: Caroline Jacqueline Denise BERDOU, Palaiseau (FR); Sylvain Yves Jean Duval, Tournan En Brie (FR)

(73) Assignee: SNECMA, Paris (FR)

(21) Appl. No.: 12/888,022

(22) Filed: Sep. 22, 2010

(30) Foreign Application Priority Data
Sep. 23, 2009 (FR) 09 56573

(51) Int. Cl. F02K 3/10

(52) U.S. Cl. 60/765

(57) ABSTRACT

A flame-holder device for the afterburning of a bypass turbojet, said turbojet comprising first and second internal annular casings, defining a passageway for a main flow, and an external annular casing defining with said first internal annular casing a passageway for a bypass flow, comprising:

at least one metal arm support designed to be attached to said external casing by means of a top plate,

at least one flame-holder arm, having a trough shape making a cavity, designed to be attached to the arm support, and

at least one screen for the heat protection of the arm cavity, the arm support and the heat-protection screen being in one piece.

The field of the present invention is that of bypass turbojets and more particularly of the afterburner devices of such jets.

### BACKGROUND OF THE INVENTION

In a bypass turbojet with afterburner, with an afterbody of the type illustrated in FIGS. 1 and 2, the cool airflow is first of all aspirated by a low-pressure compressor upstream of the engine. A first portion of this airflow coming out of the low-pressure compressor feeds a high-pressure compressor, while a second portion passes into a first passageway 1 defined between an external annular casing 2 and a first internal annular casing 3.

The airflow compressed by the high-pressure compressor feeds, from upstream to downstream, a combustion chamber which itself feeds a high-pressure turbine with combustion gases, followed by a low-pressure turbine from which the outlet passes through a second passageway 4 defined between the first internal annular casing 3 (or confluence metal plate) and a second internal annular casing 5 (or exhaust cone).

The combustion gases which feed the second passageway 4 have a high temperature and constitute what is called a main flow (or hot flow). The air that feeds the first passageway 1 has a substantially lower temperature than the main flow and constitutes what is called a bypass flow (or cold flow).

Downstream of the turbine outlet, it is possible to achieve an increase in thrust by injecting an additional quantity of fuel into the main and bypass flows, with its combustion within an afterburner channel. With reference to FIG. 2, this system mainly comprises an arm assembly 7, called flame-holder arm, and a spray ring 6. The spray ring 6 is supported by the arms 7 and placed in the bypass flow in the vicinity of the confluence metal plate 3. A portion of the injection is carried out with the aid of the spray ring 6 which makes it possible to evenly inject a portion of the fuel and to stabilize the flame. Moreover, each arm 7 contains a fuel injector 16 which injects into the main flow 4 the other portion of the afterburner fuel.

The arm 7 is also fitted with a ventilation tube 17 the role of which is to cool on the one hand the metal walls of the arm 7 washed by the main flow, and, on the other hand, the fuel injector 16 with the air originating directly from the cold flow.

The injector-tube assembly is itself protected from the radiation of the flame by another metal part, the heat-protection screen 10.

### DESCRIPTION OF THE PRIOR ART

In the prior art, the arms 7 were initially made of metal and were cast. This configuration had the drawback of having to provide for their cooling. In more recent embodiments, they have been replaced by parts made of ceramic matrix composite (CMC) material which have the advantage of being lighter and of better withstanding high temperatures. It is then possible to lighten the ventilation systems which the metal systems have to sustain.

On the other hand, these materials have heat expansion characteristics that are very different from those of the materials constituting the metal screens with which they are attached. It is therefore necessary to take account of the effects of these differences in the way in which the CMC arms 7 are connected to the metal heat-protection screens 10. With reference to FIG. 2, the heat-protection screen 10 protecting the cavity of an arm 7 is conventionally attached to the arm 7 by rivets 11 and spacers placed in the bottom and top portions of the arm 7. The great difference of expansion between the CMC arm 7 and the metal protection screen 10 may cause a loss of tightening between the two parts when hot. Moreover, attaching the protection screen 10 to the CMC arm 7 generates stresses at the rivets 11. Because of the manufacturing tolerances of the CMC arm 7, the protection screen 10 has to be counterbored in order to allow a correct alignment of the orifices made in the arm with those made in the protection screen 10 for the installation of the rivets 11. These bores are sources of stress and fatigue for the protection screen 10.

Similarly, there are expansion differences between the arm 7 and the external casing 2 to which the arm is attached. Document FR2865502 from the applicant describes a one-piece flame-holder arm made of ceramic matrix composite (CMC) material to withstand high temperatures, which is attached directly to the external casing. This arm has the shape of two secured walls connected at the bottom via a groove, with, at the top, a recess open to the cold flow and two curved flanges. The attachment is achieved by these two flanges which are bolted to the casing, which, during manufacture of the arm, requires the fibers of the composite material to be bent to give them the appropriate shape. As indicated above, these flanges made of composite material do not have the same coefficient of expansion as the metal of the casing. Consequently, on the one hand, the great difference of expansion between the CMC arm and the metal casing may cause a loss of tightness between the two parts when hot, and, on the other hand, attaching the CMC arms to the casing generates stresses in the flanges of the arms. The consequences of these stresses are furthermore amplified by the fragility of the flanges in this zone due to the bending of the CMC fibers. These stresses are quite clearly prejudicial to the length of their service life.

The object of the invention is to eliminate at least some of the drawbacks.

### SUMMARY OF THE INVENTION

The invention relates to a flame-holder device for the afterburning of a bypass turbojet, said turbojet comprising first and second internal annular casings, defining a passageway for a main flow, and an external annular casing defining with said first internal annular casing a passageway for a bypass flow, comprising:
at least one metal arm support designed to be attached to said external casing by means of a top plate,
at least one flame-holder arm, having a trough shape making a cavity, designed to be attached to said arm support, and
at least one screen for the heat protection of the arm cavity, the arm support and the heat-protection screen being in one piece.

Advantageously, it is not necessary to bore into the heat-protection screen to connect it to the flame-holder arm, which increases the service life of the protection screen. Moreover, such an installation makes it possible to make use of an arm made of composite material because the connection between the arm and the arm support takes place in the bypass flow (cold flow), which limits the thermal expansions in comparison with a connection in the main flow (hot flow) as was done in the prior art. Moreover, this eliminates the machining of bores and counterbores for the attachment which saves time and cost, the elimination of the rivets and of the spacers also causing a reduction in the weight of the device.

Preferably, the arm support comprises a bottom plate forming the top face of the trough of which the heat-protection screen has the shape.

Advantageously, the protection screen is incorporated into the bottom plate which makes it possible to increase compactness without changing the position of the fuel injector and of the ventilation tube in the arm.

Again preferably, the device comprises prestress means arranged to attach the protection screen in the flame-holder arm.

Preferably, the protection screen is attached in the flame-holder arm in order to limit the vibrations of the bottom end of the protection screen. Attachment by prestress means advantageously makes it possible to compensate for the differences in thermal expansion between the protection screen and the flame-holder arm.

According to one embodiment of the invention, the protection screen comprises bosses in order to provide a prestress with an internal wall of the flame-holder arm.

Preferably, the flame-holder arm comprises, opposite the bosses of the protection screen, at least one hollow zone arranged to allow the mounting and the positioning of the protection screen with the flame-holder arm, the hollow zone advantageously making it possible to center and guide the arm when it is installed with the bosses of the protection screen.

Again preferably, the bosses are arranged in the bottom portion of the protection screen. Advantageously this makes it possible to limit the range of movement of the screen and promote the attenuation of the vibrations.

According to one embodiment of the invention, the device comprises a shoe, placed in the cavity of the flame-holder arm, arranged to maintain an air gap between the flame-holder arm and the protection screen at the trailing edge, in which the shoe comprises spacing lugs securely attached to the protection screen, said spacing lugs forming said prestress means.

The shoe therefore fulfills a function of retaining the arm elements protected by the protection screen (fuel injector, ventilation tube), a function of spacing the protection screen from the flame-holder arm and a function of prestress attachment of the protection screen to the flame-holder arm.

Preferably, the flame-holder arm comprises, opposite the spacing lugs, at least one hollow zone arranged to allow the mounting and the positioning of the protection screen with the flame-holder arm, the hollow zone advantageously making it possible to center and guide the arm when it is mounted with the shoe.

Preferably, the flame-holder arm is made of a composite material, preferably of a ceramic matrix composite (CMC) material.

The invention also relates to a method for mounting a flame-holder arm of a device as explained above with a protection screen according to the invention, a method wherein:
the metal arm support is attached to the external casing by means of the top plate, the arm support and the protection screen being in one piece;
the flame-holder arm is moved so that the bosses of the protection screen enter the hollow zone of the flame-holder arm, the flame-holder arm then being centered relative to the protection screen;
a prestress is applied to the protection screen at its bosses so as to secure the flame-holder arm to the protection screen, and
the flame-holder arm is attached to said arm support at the top portion of the flame-holder arm.

Advantageously, making the bosses correspond with the hollow zone makes it possible to position the flame-holder arm precisely relative to the protection screen, which makes it easier to attach the flame-holder arm with its support.

Preferably, the ventilation tube is positioned and welded to the arm support prior to attaching the arm support to the external casing.

Again preferably, the fuel injector is inserted from the external casing after attaching the arm support to the external casing.

The invention also relates to the mounting of a flame-holder device with a retention shoe as explained above, wherein
a ventilation tube is inserted into the retention shoe,
the bottom portion of the ventilation tube is welded to the retention shoe in the desired position,
a first assembly, formed of the retention shoe and the ventilation tube, is then welded to a second assembly, formed by the arm support and the one-piece protection screen, the top portion of the ventilation tube being centered in the bottom plate of the arm support,
the second assembly, secured to the first assembly, is attached to the external casing by means of the top plate of the arm support,
a fuel injector is inserted, from the external casing, into the retention shoe,
the flame-holder arm is moved so that the spacing lugs of the retention shoe enter the hollow zone of the flame-holder arm, the flame-holder arm then being centered relative to the heat-protection screen;
a prestress is applied to the heat-protection screen at the spacing lugs so as to secure the flame-holder arm with the protection screen, and
the flame-holder arm is attached to said arm support at the top portion of the flame-holder arm.

Advantageously, this makes it possible to mount the ventilation tube and the fuel injector correctly and accurately in the arm.

### BRIEF DESCRIPTION OF THE DRAWINGS

The invention will be better understood and other objects, details, features and advantages of the latter will appear more clearly in the course of the following detailed explanatory description of several embodiments of the invention given as purely illustrative and nonlimiting examples, with reference to the appended drawing in which:

FIG. 1 is a view in section of an afterbody of a bypass turbojet with afterburner ;

FIG. 2 is a view in section of a flame-holder arm according to the prior art;

FIG. 3A is a view in perspective of the top portion of a flame-holder arm support with a heat-protection screen according to the invention;

FIG. 3B is a view in perspective of the bottom portion of the protection screen of FIG. 3A mounted in the cavity of a flame-holder arm, and

FIG. 4 represents a view in section of a spacing shoe in the cavity of a flame-holder arm according to the invention.

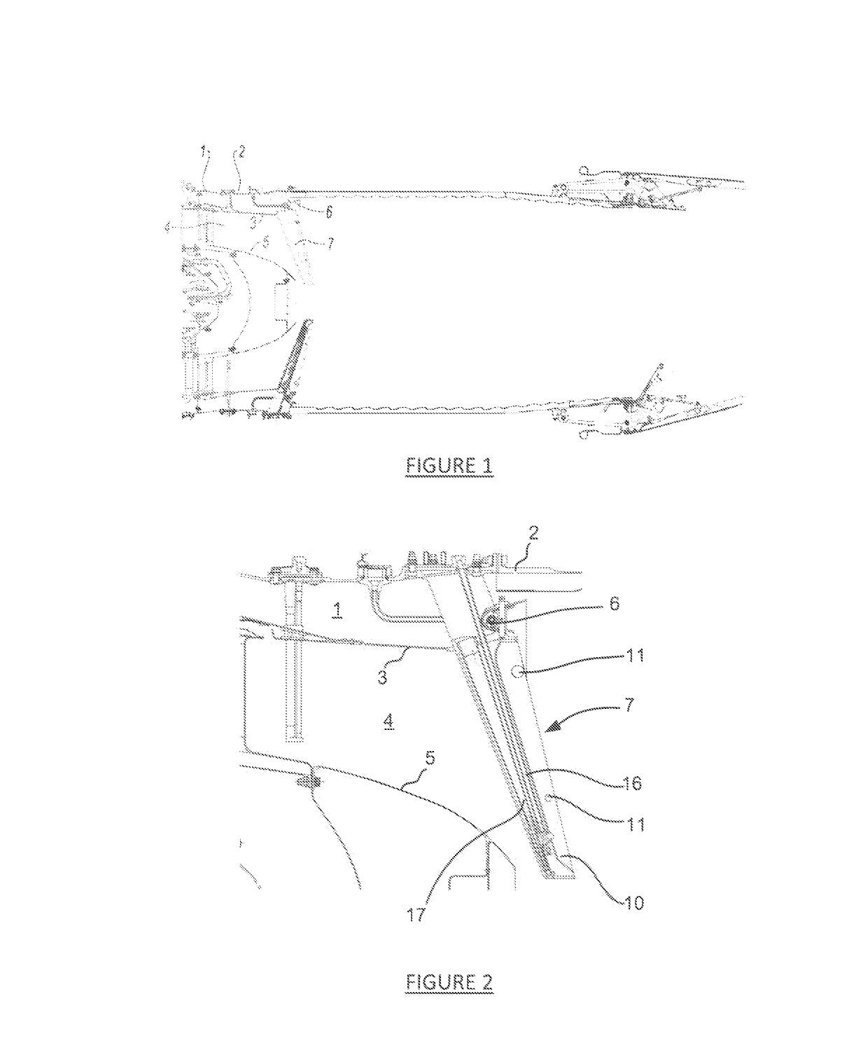

In the rest of the text, the words “bottom” and “top” are defined according to FIG. 2, the top portion of the flame-holder arm 7 being connected to the external casing 2, its bottom portion extending radially toward the axis of the turbojet.

### DESCRIPTION OF THE PREFERRED EMBODIMENTS

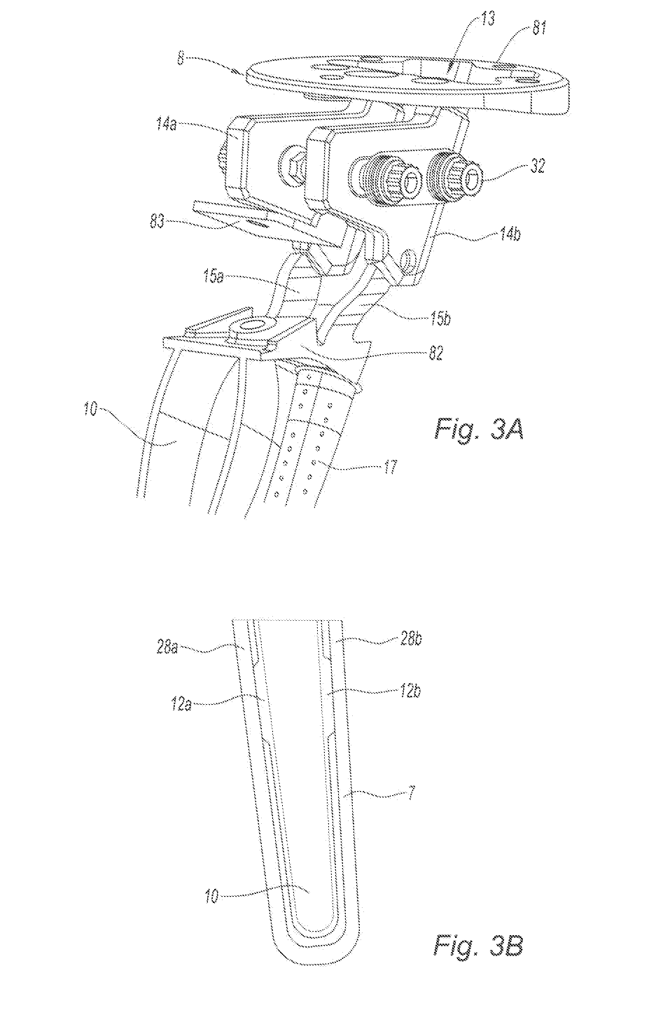

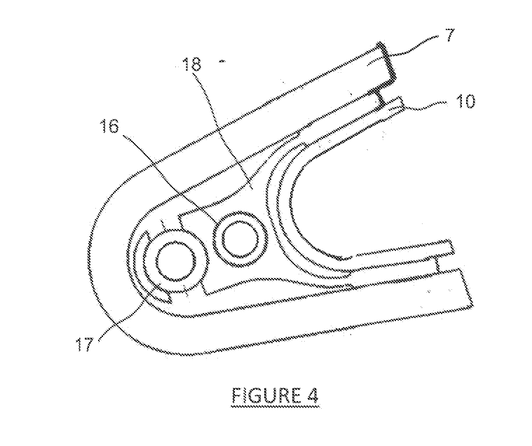

With reference to FIG. 3A, it shows a device comprising an arm support 8 with a top plate 81 designed to be attached to the external casing 2 of the turbojet by means of four bolt-nuts, not shown. The top plate 81 also comprises a bore 13 through which a fuel injector, not shown, passes.

From the top plate 81 extend two lateral masts 14a and 14b, shown here, without this shape being essential, in the shape of a T turned through 90°, the top branch of the T developing from the top plate 81 and serving at its other end as a support with two branches 15a and 15b supporting a bottom plate 82.

The bottom plate 82 comprises two bores into which the fuel injector 16 and a ventilation tube 17 pass respectively, via a swivel connection allowing the tube to move freely.

To the central branch of the T of each of the lateral masts 14a and 14b is attached an intermediate plate 83 which, with the bottom plate 82, is intended to serve as a support for a spray ring not shown. Accordingly, the intermediate plate 83 comprises a bore into which passes a means, not shown, for attaching the external portion of the spray ring, while the bottom plate 82 comprises a bore into which passes a means, not shown, for attaching the internal portion of the spray ring. The bottom plate 82 also comprises two bearing faces which constitute, with the top portion of the bore, a bearing face on which the internal portion of the spray ring rests. In order to minimize the heat transfers to the arm support 8 of the spray ring, the internal portion of which is situated in the hot flow, the surfaces of contact between the spray ring and the bottom plate 82 are reduced as much as possible; consequently, the surface of the bearing faces and of the bore represent at most 25% of the surface of the bottom plate 82.

The bottom plate 82 of the arm support 8 is secured to the top portion of the heat-protection screen 10 of the arm 7, the protection screen 10 and the arm support 8 being one-piece cast metal parts. The protection screen 10 takes the form of a trough with a U section, open in the downstream direction, the top face of which is constituted by the bottom plate 82 of the arm support 8 (FIG. 3A), the bottom face of the protection screen 10 being, for its part, substantially rounded (FIG. 3B). In this example, the upstream portion of the bottom plate 82 comprises bores for the fuel injector and the ventilation tube to pass through, the downstream portion of the bottom plate forming the top face of the screen.

The arm support 8 with the protection screen incorporated advantageously makes it possible to no longer attach the flame-holder arm 7 with the top portion of the heat-protection screen 10 but only with its support 8. This dispenses with the differences of thermal expansion between the flame-holder arm 7 and the protection screen 10.

With reference now to FIG. 3B, the flame-holder arm 7 takes the form of a one-piece structure made of composite material having the shape of a trough making a cavity. It is preferably made of ceramic matrix composite (CMC) which is particularly resistant to high temperatures and which is lightweight compared with metal materials. As an example, the structure is made from a preform of fibers, notably of silicon carbide or carbon, impregnated with a liquid-phase ceramic matrix.

The flame-holder arm 7 comprises two substantially symmetrical walls 28a and 28b which join together on a longitudinal side so as to define a groove of which the profile, in a cross section, is substantially V-shaped. These two walls join together at their internal end, that is to say the end that is oriented toward the center of the gas stream, in order to form a foot which has the shape of a bevel in order to lie in the axis of the main flow and make it easier for the air to pass through.

With reference to FIG. 3A, the arm 7 and the arm support 8 are held in position by four bolts 32 which pass in turn through the arm 7, through two holes made in the wall of the arm 7 and counterbores made in the lateral masts 14a, 14b of the arm support 8. A backplate is positioned between the head of each screw and the corresponding wall of the arm 7 in order, in a known manner, to spread the tightening forces and protect the CMC material in compression when the bolts are tightened. Between the head of the screw and the backplate, elastic shims are also inserted which maintain the tightness despite the expansion differences that exist, when hot and when cold, between the arm 7 and the bolt 32. Attaching the arm 7 with its support in the cold flow advantageously makes it possible to limit the stresses associated with thermal expansion.

Advantageously, a prestress is applied between the protection screen 10 and the flame-holder arm 7 so as to limit the range of movement of the bottom end of the protection screen 10. Specifically, in operation, the bottom end of the protection screen 10 begins to vibrate which is prejudicial to the service life of the screen 10 as of the flame-holder arm 7.

With reference to FIG. 3B, the protection screen 10 comprises, in its bottom portion, prestress means in order to attach the protection screen 10 in the flame-holder arm 7. These prestress means may take several forms and are not limited to the two embodiments that will be proposed below. In this example, an axial prestress is applied along the axis of the engine, between the protection screen 10 and the flame-holder arm 7.

According to a first embodiment, the protection screen 10 comprises bosses 12a, 12b to provide a prestress with the internal wall of the flame-holder arm 7, the bosses forming a local extra thickness in the wall of the protection screen 10. With reference to FIG. 3B, the protection screen 10 comprises two bosses 12a, 12b made on the external lateral walls of the protection screen 10, the bosses 12a, 12b extending toward the outside of the protection screen 10, in the direction opposite to the cavity of the protection screen 10. The bosses 12a, 12b in this instance extend longitudinally, in the length of the protection screen 10, and have a predetermined thickness in order to prestress the protection screen 10 in the flame-holder arm 7 while making an air gap of sufficient thickness to prevent the transfer of heat between the protection screen 10 and the flame-holder arm 7. The length of the bosses 12a, 12b is the result of a compromise between a considerable length improving the prestress and limiting the transmission of vibrations, and a short length limiting the transfer of heat between the protection screen 10 and the flame-holder arm 7. Similarly, the width of the bosses can be optimized to ensure a good vibration-resistance, this width forming an air gap between the screen and the arm to allow air and fuel originating from the fuel injector and from the ventilation tube to pass through.

By virtue of the invention, it is possible to mount the flame-holder arm 7 with the protection screen 10 without boring into the protection screen 10. Advantageously this makes it possible to dispense with the differences of expansion between the parts of the device. The mounting takes place in the following manner:
the ventilation tube 17 is positioned and then attached to the one-piece arm support 8/protection screen 10 assembly, making sure to have correctly installed the spherical centering in the corresponding orifice of the bottom plate 82 of the arm support,
the whole assembly is then attached to the external casing 2 by means of the top plate 81,
the fuel injector 16 is put in place by inserting it from the external casing,
the flame-holder arm then being centered relative to the heat-protection screen 10, the heat-protection screen 10 is moved in the flame-holder arm 7 so that the bosses 12a and 12b apply a prestress, and
the flame-holder arm 7 is attached to said arm support 8, at its top portion, with the aid of the bolts 32.

Attaching the arm 7 with the support 8 by means of bolts 32 is a simple procedure; the protection screen 10 is bored into neither in its top portion, nor in its bottom portion, which limits the occurrence of fatigue and stress.

According to an alternative not shown, the flame-holder arm 7 comprises, opposite the bosses 12a, 12b of the protection screen 10, at least one hollow zone arranged to allow easy mounting of the protection screen 10 with the flame-holder arm 7. In this example, a hollow zone is arranged opposite each boss, the hollow zone serving as a pivot and guide in which the boss moves.

This variant is mounted as above, except that the flame-holder arm 7 is placed so that the bosses of the protection screen 10 enter the hollow zone of the flame-holder arm 7 before the heat-protection screen 10 is inserted into the flame-holder arm 7.

A prestress is applied to the protection screen 10 at its bosses 12a, 12b in the axial direction, the protection screen 10 moving in the cavity of the arm 7 so as to align the orifices for attaching the arm with those of the support. The flame-holder arm 7 is attached to said arm support 8 with the aid of the bolts 32.

The hollow zone of the arm makes it possible to perfectly line up the orifices for attaching the arm 7 with those of its support 8, in the bypass flow, when the screen 10 is prestressed.

A protection screen 10 with bosses 12a, 12b and a flame-holder arm 7 with corresponding hollow zones has been proposed. As an equivalent, it goes without saying that the flame-holder arm 7 could comprise bosses and the protection screen one or more corresponding hollow zones.

In a second embodiment, with reference to FIG. 4, the device comprises a retention shoe 18, placed in the cavity of the flame-holder arm 7, arranged to maintain an air gap between the flame-holder arm 7 and the protection screen 10. Such a shoe 18, known for example through patent application FR 2928202, comprises a flat body with radial orifices in order to allow the passage and the retention of the fuel injector 16 and of the ventilation tube 17. The shoe 18 also comprises spacing lugs arranged in order to extend between the lateral walls of the protection screen 10 and of the arm 7.

With reference to FIG. 4, the lugs are attached securely to the protection screen 10, said spacing lugs forming said means for prestressing the protection screen 10 in the flame-holder arm 7. The lateral walls of the protection screen 10 and of the arm 7 are then separated by an air gap corresponding to the thickness of the lugs. The lugs of the shoe make it possible, like the bosses, to add an extra thickness to the walls of the protection screen 10 which allows attachment by prestress. In this example, the lugs of the shoe 18 are welded to the protection screen 10. It goes without saying that other means could equally be appropriate (brazing, etc.).

When a fuel injector and a ventilation tube are mounted into the flame-holder arm with a retention shoe 18 as explained above, the ventilation tube 17 is inserted into an orifice of the retention tube. The bottom portion of the ventilation tube 17 is welded, correctly positioned, onto the retention shoe 18, and then the shoe 18/ventilation tube 17 assembly is welded to the arm support 8/one-piece protection screen 10 assembly, again making sure to have correctly put in place the spherical centering of the ventilation tube 17 in the corresponding orifice of the bottom plate 82 of the arm support 8. As above, the fuel injector 16 is put in place by inserting it from the external casing, the fuel injector is inserted from the external casing 2, into the retention shoe 18. The flame-holder arm 7 is moved so that the spacing lugs of the retention shoe 18 enter the hollow zone of the flame-holder arm 7, the flame-holder arm 7 then being centered relative to the heat-protection screen 10. Then, a prestress is applied to the heat-protection screen 10 at the spacing lugs so as to secure the flame-holder arm 7 with the protection screen 10, and the flame-holder arm 7 is attached to said arm support 8 at its top portion.

Such an assembly makes it possible to keep the elements precisely housed in the cavity of the arm while avoiding making bores.

1. A flame-holder device for the afterburning of a bypass turbojet, said turbojet comprising first and second internal annular casings, defining a passageway for a main flow, and an external annular casing defining with said first internal annular casing a passageway for a bypass flow, comprising:
at least one metal arm support designed to be attached to said external casing by means of a top plate,
at least one flame-holder arm, having a trough shape making a cavity, designed to be attached to the arm support, and
at least one screen for the heat protection of the arm cavity, the arm support and the heat-protection screen being in one piece, the device comprising prestress means arranged to attach the protection screen in the flame-holder arm.

2. The device as claimed in claim 1, wherein the arm support comprises a bottom plate forming the top face of the trough of which the heat-protection screen has the shape.

3. The device as claimed in claim 1, wherein the protection screen comprises bosses in order to provide a prestress with an internal wall of the flame-holder arm.

4. The device as claimed in claim 3, wherein the flame-holder arm comprises, opposite the bosses of the protection screen, at least one hollow zone arranged to allow the mounting and the positioning of the protection screen with the flame-holder arm.

5. The device as claimed in claim 3, wherein the bosses are arranged in the bottom portion of the protection screen.

6. The device as claimed in claim 1, comprising a retention shoe, placed in the cavity of the flame-holder arm, arranged to maintain an air gap between the flame-holder arm and the protection screen, in which the shoe comprises spacing lugs securely attached to the protection screen, said spacing lugs forming said prestress means.

7. The device as claimed in claim 6, wherein the flame-holder arm comprises, opposite the spacing lugs of the shoe, at least one hollow zone arranged to allow the mounting and the positioning of the protection screen with the flame-holder arm.

8. A method for mounting a flame-holder arm of a device as claimed in claim 4 with a protection screen according to the invention, a method wherein:
the metal arm support is attached to the external casing by means of the top plate, the arm support and the protection screen being in one piece;
the flame-holder arm is moved so that the bosses of the protection screen enter the hollow zone of the flame-holder arm, the flame-holder arm then being centered relative to the protection screen;
a prestress is applied to the protection screen at its bosses so as to secure the flame-holder arm to the protection screen, and
the flame-holder arm is attached to said arm support at the top portion of the flame-holder arm.

9. The method for mounting a device as claimed in claim 7, wherein:
a ventilation tube is inserted into the retention shoe,
the bottom portion of the ventilation tube is welded to the retention shoe in the desired position,
a first assembly, formed of the retention shoe and the ventilation tube, is then welded to a second assembly, formed by the arm support and the one-piece protection screen, the top portion of the ventilation tube being centered in the bottom plate of the arm support,
the second assembly, secured to the first assembly, is attached to the external casing by means of the top plate of the arm support,
a fuel injector is inserted, from the external casing, into the retention shoe,
the flame-holder arm is moved so that the spacing lugs of the retention shoe enter the hollow zone of the flame-holder arm, the flame-holder arm then being centered relative to the heat-protection screen;
a prestress is applied to the heat-protection screen at the spacing lugs so as to secure the flame-holder arm with the protection screen, and
the flame-holder arm is attached to said arm support at the top portion of the flame-holder arm.
